(19) United States
(12) Patent Application Publication
(10) Pub. No.: US 2026/0024307 A1
(43) Pub. Date: Jan. 22, 2026

(54) TASK ANALYSIS METHOD, INFORMATION PROCESSING SYSTEM, AND STORAGE MEDIUM

(71) Applicant: KONICA MINOLTA, INC., Tokyo (JP)

(72) Inventors: Ryo MORITA, Tokyo (JP); Yoshihiro MURAJI, Tokyo (JP); An SONG, Tokyo (JP)

(73) Assignee: KONICA MINOLTA, INC., Tokyo (JP)

(21) Appl. No.: 19/262,159

(22) Filed: Jul. 8, 2025

(30) Foreign Application Priority Data
Jul. 18, 2024 (JP) 2024-114496

(51) Int. Cl. G06V 10/74; G06T 7/73

(52) U.S. Cl. CPC G06V 10/761; G06T 7/73; G06T 2207/20044

(57) ABSTRACT

A task analysis method includes, presetting a captured image of an operation of an operator at a start of a predetermined task as a reference start image, and presetting the captured image of the operation of the operator at an end of the task as a reference end image; acquiring imaging data of the predetermined task repeated a plurality of times; extracting, from the acquired imaging data, a first candidate for the operation at the start based on a first similarity to the reference start image and a second candidate for the operation at the end based on a second similarity to the reference end image; and specifying a task period by evaluating validity of a third candidate of the task period defined by a combination of the extracted first candidate and second candidate.

### CROSS-REFERENCE TO RELATED APPLICATIONS

The entire disclosure of Japanese Patent Application No. 2024-114496, filed on Jul. 18, 2024, including description, claims, drawings and abstract is incorporated herein by reference.

### BACKGROUND OF THE INVENTION

### Technical Field

The present disclosure relates to a task analysis method, an information processing system, and a storage medium.

### Description of Related Art

Even at a task site where products are manually assembled, it is important to improve efficiency of tasks. Japanese Unexamined Patent Publication No. 2022-3491 discloses a technique of extracting two kinds of motions that repeatedly appear in data obtained by imaging a task of an operator, and estimating a time required for the motion other than task operation on the basis of a time interval between the two kinds of motions.

However, in a case where an arbitrary motion is extracted from image data, there is a problem in that it is difficult to cope with a case where the arbitrary motion is erroneously extracted, and it is difficult to improve accuracy.

### SUMMARY OF THE INVENTION

An object of the present disclosure is to provide a task analysis method, an information processing system, and a storage medium capable of specifying a task period of a repetitive task with more accuracy.

According to one aspect of the present disclosure, a task analysis method according to an aspect of the present disclosure includes:
presetting a captured image of an operation of an operator at a start of a predetermined task as a reference start image, and presetting the captured image of the operation of the operator at an end of the task as a reference end image;
acquiring imaging data of the predetermined task repeated a plurality of times;
extracting, from the acquired imaging data, a first candidate for the operation at the start based on a first similarity to the reference start image and a second candidate for the operation at the end based on a second similarity to the reference end image; and
specifying a task period by evaluating validity of a third candidate of the task period defined by a combination of the extracted first candidate and second candidate.

According to another aspect of the present disclosure, an information processing system includes:
a hardware processor, wherein the hardware processor is configured to perform.
presetting a captured image of an operation of an operator at a start of a predetermined task as a reference start image, and presetting the captured image of the operation of the operator at an end of the task as a reference end image.
acquiring imaging data of the predetermined task repeated a plurality of times.
extracting, from the acquired imaging data, a first candidate for the operation at the start based on a first similarity to the reference start image and a second candidate for the operation at the end based on a second similarity to the reference end image, and
specifying a task period by evaluating validity of a third candidate of the task period defined by a combination of the extracted first candidate and second candidate.

According to another aspect of the present disclosure, a non-transitory computer-readable storage medium storing a program that causes a computer to perform.
presetting a captured image of an operation of an operator at a start of a predetermined task as a reference start image, and presetting the captured image of the operation of the operator at an end of the task as a reference end image.
acquiring imaging data of the predetermined task repeated a plurality of times.
extracting, from the acquired imaging data, a first candidate for the operation at the start based on a first similarity to the reference start image and a second candidate for the operation at the end based on a second similarity to the reference end image, and
specifying a task period by evaluating validity of a third candidate of the task period defined by a combination of the extracted first candidate and second candidate.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a block diagram illustrating a functional configuration of an information processing apparatus:

FIG. 2 is a diagram illustrating a sequence of a task detection operation:

FIG. 3 is a diagram illustrating an example of a change in a horizontal direction position of a right wrist:

FIG. 4 is a diagram describing dynamic programming:

FIG. 5 is a diagram illustrating an example of an extracted candidate for a task start and a task end and an example of specified timings of the task start and the task end:

FIG. 6 is a graph illustrating a maximum value of an evaluation value with respect to a provisional number of times of a task:

FIG. 7 is a flowchart illustrating a control procedure of task analysis control processing; and

FIG. 8 is a flowchart illustrating another example of the task analysis control processing.

### DETAILED DESCRIPTION

Hereinafter, one or more embodiments of the present disclosure will be described with reference to the drawings. However, the scope of the invention is not limited to the disclosed embodiments.

Hereinafter, embodiments of the present disclosure will be described with reference to the drawings.

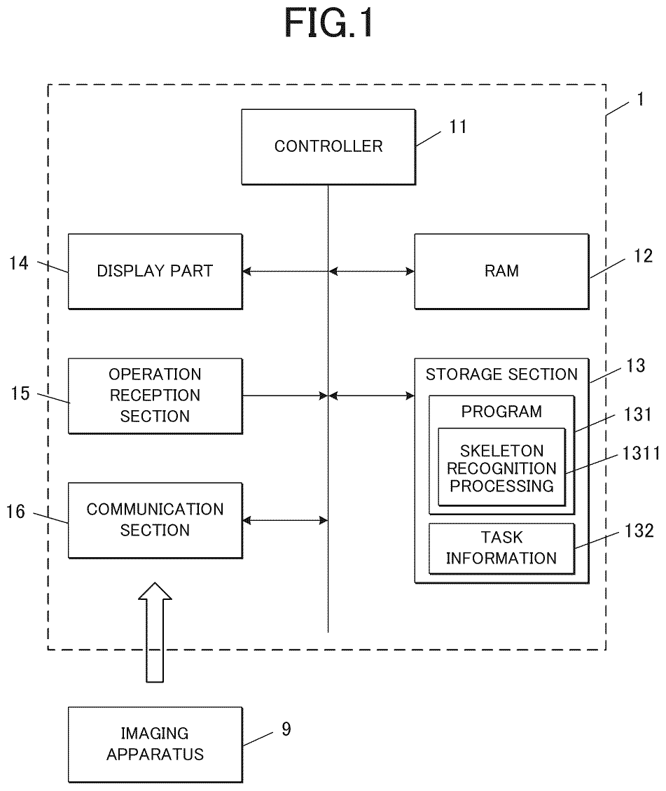

FIG. 1 is a block diagram illustrating a functional configuration of an information processing apparatus 1 according to an information processing system of the present embodiment.

The information processing apparatus 1 may be a computer (electronic calculator) such as a normal personal computer (PC). The information processing apparatus 1 includes a controller 11 (hardware processor), a RAM 12, a storage section 13, a display part 14, an operation reception section 15, and a communication section 16.

The controller 11 includes a hardware processor that performs arithmetic processing and comprehensively controls the entire operation of the information processing apparatus 1. The controller 11 is a configuration included in at least a computer. The hardware processor may be a general-purpose hardware processor (CPU). Alternatively, the hardware processor may cause a plurality of CPUs to perform arithmetic processing in parallel, or a plurality of hardware processors may perform arithmetic processing independently of each other according to the use or the like. Furthermore, some or all of the hardware processors may be suitably designed for specific applications, such as image processing.

The RAM 12 provides a working memory space for the controller 11 and stores temporary data. The RAM 12 may be, for example, a DRAM.

The storage section 13 includes a nonvolatile memory that stores a program 131, setting data, and the like. The nonvolatile memory may be, for example, a flash memory. Furthermore, the nonvolatile memory may include a hard disk drive (HDD). Some or all of the storage sections 13 may be an auxiliary storage device externally attached to the information processing apparatus 1 as a peripheral device. Alternatively, some or all of the storage sections 13 may be a network drive, a cloud server, or the like on a network. The storage section 13 also stores captured image data to be analyzed.

The program 131 detects the start and end of the task from a captured image obtained by photographing the repetition of the specific task, and specifies the period of the task of the set number of times. The program 131 includes skeleton recognition processing 1311. The skeleton recognition processing 1311 identifies, from the captured image, positions of specific points related to a skeleton of a person to be imaged, for example, both eyes, top of a nose, both ends of a mouth, a neck, a shoulder, an elbow, a wrist, and a waist. In a case where the task is a standing task or the like and a lower body is also imaged, in addition to the above, knees, ankles, toes, and the like can also be targets to be specified.

The setting data may include task information 132 on the person to be imaged who is an operator who performs a predetermined task. The task information 132 may include information on the number of times of the task repeated by the person to be imaged during an imaging period.

The display part 14 may include a digital display screen for digitally displaying various information. The digital display screen may be, for example, a liquid crystal display screen or an organic electro-luminescent (EL) display screen. The display part 14 may be a peripheral device externally attached to the information processing apparatus 1.

The operation reception section 15 accepts an input operation from the outside such as a user, and outputs an electrical signal corresponding to an input operation to the controller 11. The operation reception section 15 may include a keyboard, a pointing device such as a mouse, and/or a touch screen. Some or all of the operation reception sections 15 may be a peripheral device externally attached to the information processing apparatus 1.

The communication section 16 controls communication connection with an external device via a local area network (LAN), a wireless LAN, or the Internet. The communication section 16 may include a network card or the like. Further, the communication section 16 may be directly connectable to an external device or a peripheral device via a universal serial bus (USB), short-range wireless communication, or the like. The external device connected in this manner may include an imaging apparatus 9) or another information processing apparatus that has received imaging data from the imaging apparatus 9. Alternatively, the communication section 16 may include a terminal for connecting a portable recording medium on which imaging data is recorded, for example, an SD card.

The image data acquired from the imaging apparatus 9 and to be an analysis target is a moving image. However, as long as a characteristic posture or movement can be identified as will be described later, the number of captured images per unit time, that is, the number of frames may be small to the extent that the motion does not appear smooth when viewed. For example, the image data may be an image of about several frames per second. Furthermore, the captured image does not need to be data in a moving image format. The captured image may be continuous still images.

Next, a task detection operation according to a task analysis method of the present embodiment will be described.

The information processing apparatus 1 of the present embodiment detects the start and the end of the task from the captured image of the predetermined task repeatedly executed by the operator. As a result, each task time of the operator and the time of the non-task period between the task periods are specified. The predetermined task mentioned here may be a business task mainly in a factory or the like, and may be, for example, a product assembly task, an adjustment task, an inspection task, or the like. The non-task period includes a break including absence, standby, and the like. The breaks may include a defined break, a necessary break, and slacking off. The standby may include a period of time from the end of a certain task to the start of the next task after the end of the task upstream of a task process. The task detection operation of the present embodiment does not need to be performed in real time. The acquired captured image having a certain time width are collectively set as a task detection target later.

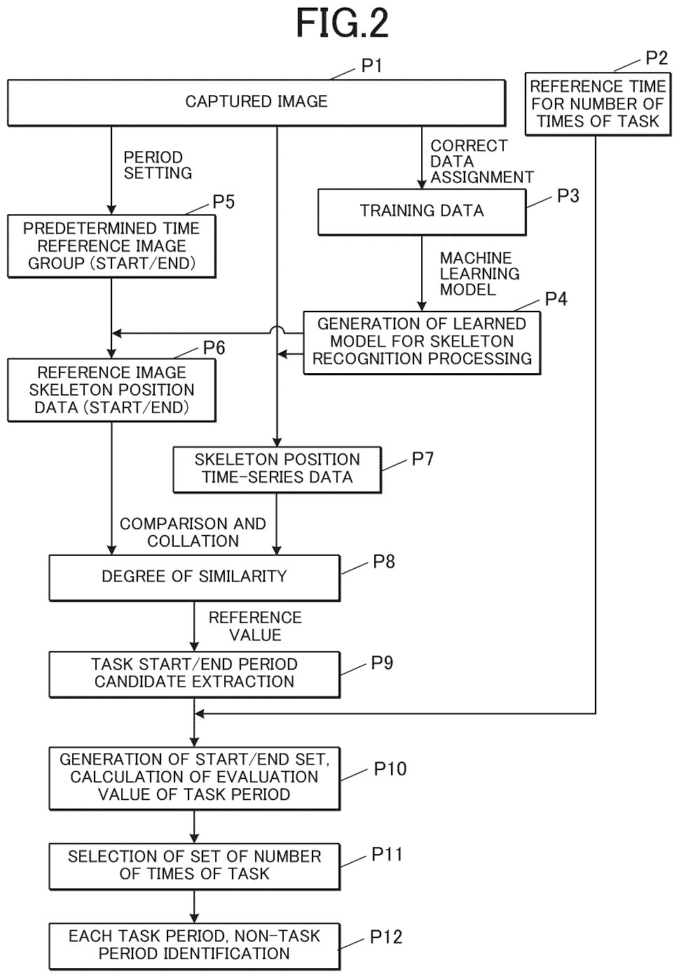

FIG. 2 is a diagram illustrating a sequence of a task detection operation.

The information processing apparatus 1 acquires the data of the captured image of the task by an analysis target person directly from the imaging apparatus 9 or via another information processing apparatus or the like (P1: acquiring step, acquiring means). In the captured image, the task repeated a plurality of times is captured, and the number of times of the task may be large to the extent that statistical variation does not have to be considered. Specifically, the number of times of the task may be 10 times or more, and may be 100 times or more. The task time of the analysis target person is specified from the data of the acquired captured image.

The information on the number of times of the task and the information on the reference time (standard time span) which is an average task time may be input separately from information such as a number of products obtained by the task, for example (P2). The reference time may not be limited to the task time by the analysis target person. In a case where there are a plurality of operators who perform the same task, the task time may be determined on the basis of the task time by the plurality of operators. The reference time does not have to be obtained based on an actual task. A time or the like assumed by an administrator as the reference time may be simply input.

The movement of the analysis target person may be specified by the positions of a predetermined number of skeleton points specified by the skeleton recognition processing 1311 in the program 131, the relative positional relationship, and the change thereof. The skeleton recognition processing 1311 may be performed by inputting a target image to a learned model. The learned model is not limited to a specific type of algorithm as long as it is an algorithm related to image recognition. As the learned model, an already learned general-purpose model may be acquired from the outside. Alternatively, the person in charge may generate correct data on a skeleton position with respect to a captured image of the task acquired in advance and generate training data in which the correct answer is associated with the captured image (P3). A machine learning model not yet learned may be learned using this training data to obtain a learned model for the skeleton recognition processing 1311 specialized for the image of the task (P4). Even when the learned model is generated, the captured image included in the training data may not be limited to the captured image of the task. The data of the captured image for machine learning may be captured and acquired separately from the captured image for the analysis target.

As the analysis target to be analyzed, for example, an item visually noticed by the administrator or the like may be registered. That is, it may not be a feature that is expressed in multiple dimensions (e.g., 50 or more dimensions) using a machine learning model or the like and is difficult for a human to understand.

By inputting each frame data of the captured image to the learned model, time-series data of the skeleton position in each frame is obtained (P7).

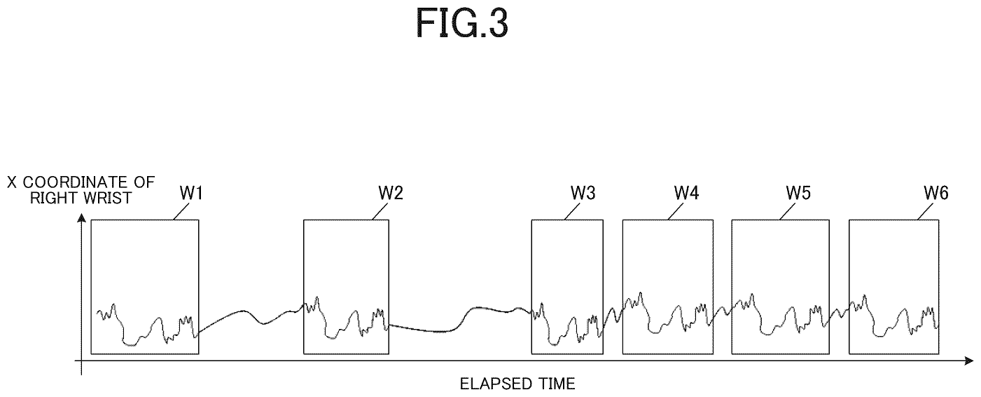

FIG. 3 is a diagram illustrating an example of a change in a horizontal direction position of a right wrist.

In the task involving the movement of the body as described above, the posture specific to the content of the task, that is, the state of the relative position of the skeleton and the change thereof are included. Here, the position of the right wrist is identified as the skeleton position, and a change in the X coordinate that is a horizontal component in the captured image is illustrated. The lateral direction of the captured image may be parallel to a horizontal direction. It can be seen that similar movements are repeatedly seen in the horizontal direction position of the right wrist, as in ranges W1 to W7. This represents the movement of the right wrist according to the task repeated a plurality of times. The information processing apparatus 1 further detects characteristic skeleton positions and movements at the start and end of such task, thereby extracting candidates for the start and end of the task. The start time and the end time of the task described herein are periods having a range of a predetermined time from the start timing of the task and a predetermined time before the end timing of the task. The predetermined time may be set in a range in which the uniqueness of the relative position or the motion of the skeleton with respect to other sections is obtained, the ratio of the predetermined time to the task time of one time is not too high, and the influence of the shake or the like of the operation of each time is unlikely to occur. For example, for the task that normally requires one minute, the predetermined time may be set to about five seconds. Alternatively, the predetermined time may not be determined in advance. A plurality of candidates may be set as the predetermined time, the subsequent processing may be executed for each of the candidates, and the time of the candidate for which the best result is finally obtained may be determined as the result for the task that is the analysis target. Furthermore, the predetermined time may be changed for each task content on the basis of uniqueness or the like of a characteristic operation corresponding to the task content. The predetermined time of the start period and the predetermined time of the end period may be different from each other.

For the start period and the end period of the predetermined task to be detected, typical operation parts are selected and set as a reference start image and a reference end image, respectively, by a person in charge or the like in the data of the captured images for machine learning. The reference start image and the reference end image are collectively referred to as a reference image group. Furthermore, a range of the predetermined time is set by an input operation or the like of the person in charge (P5: setting step, setting means). The reference image group in the set range is input to the generated learned model, and the skeleton position in the reference image group is obtained (P6).

The skeleton position in each of the reference image group obtained in P6 and the skeleton position in each image of the analysis target obtained in P7 are compared and collated with each other, and the degree of similarity is obtained (P8). The degree of similarity to the reference start image is referred to as first similarity, and the degree of similarity to the reference end image is referred to as second similarity. The degree of similarity may be quantitatively evaluated by vector operation using a characteristic vector representing a feature amount of each image. For example, for each frame, the sum or sum of squares of Euclidean distances between the skeleton positions of the captured image and the reference image group may be obtained. In this case, the coordinates on the image are used as they are as a position vector from the origin, and a difference vector can be used as a calculation target of the Euclidean distance. Further, depending on the contents of the operation or the like, the skeleton position or the like with respect to a specific origin of the photographing target person, for example, an intersection of a line connecting both shoulder points and a vertical line passing through the neck may be represented as the characteristic vector. Further, in each image, a relative positional relationship between a plurality of skeleton positions may be represented as the characteristic vector, and a Euclidean distance of a difference between the vectors may be considered. For example, the orientation of the forearm represented by a vector from the elbow to the wrist of the right hand may be used for the evaluation of the similarity. In this way, the degree of similarity can be easily quantitatively evaluated by indicating the magnitude of the mismatch as a numerical value. Note that in a case where there are a plurality of items to be compared and collated, the magnitudes of the mismatches of the plurality of items may be weighted and added.

Furthermore, a first similarity value or a second similarity value may be obtained by adding the value of the degree of similarity obtained for each frame for all frames in a predetermined period. Alternatively, for the calculation of the similarity degree, a cosine similarity of the characteristic vectors to be compared may be used instead of the Euclidean distance. An imaging direction and an enlargement ratio of the imaging apparatus 9 are fixed, and the distance may be simply a two dimensional position with reference to a certain reference point in the image. Furthermore, dynamic time warping (DTW) or the like may be applied in consideration of a shift in a time direction as well. In this case, a minimum time width and a maximum time width that can be considered in the DTW may be set in advance. When some of the obtained skeleton positions has no relationship with the start or end of the task, some of the skeleton positions may not be used for the calculation of the Euclidean distance or the cosine similarity.

When the obtained similarity degree satisfies the reference value, a predetermined period of the degree of similarity satisfying the reference value is extracted as a first candidate which is a candidate for the task start period or a second candidate which is a candidate for the task end period (P9)). The processes of P8 and P9) correspond to an extraction step and extraction means of the present embodiment. At this stage, it is sufficient that the candidates are extracted independently of each other, that is, the first candidate may continue for a plurality of times and the second candidate may continue for a plurality of times.

In this way, since the extraction targets are the start and the end of the task, the time range of the repeated task period and the time range of the non-task period such as break time between the tasks are easily specified. On the other hand, depending on the task content, the skeleton positions and changes thereof at the start and end of the task are not necessarily highly distinctive from other skeleton positions and changes thereof that appear in the task. In this case, a task portion that is not actually the start or end of the task may be erroneously recognized as the start or end. Therefore, in the task analysis method of the present embodiment, the extracted first candidate and second candidate are appropriately combined, and the inappropriate first candidate and second candidate are excluded.

A third candidate of a task period defined by combining the obtained first candidate of the task start period and a second candidate of the task end period later than the first candidate in a possible range is generated (P10). For example, the first candidate of the task start period detected first in the captured image tasks performed 100 times can be paired with all the candidates to the 100 th candidate from the last among the second candidates of the task end period detected after the first candidate. Note that at this stage, the number of times of the task and the overlap of task periods may not be considered. Furthermore, an upper limit value may be defined for the interval between the task start time and the task end time that are combined. An evaluation value indicating the degree of validity is calculated for the task period of each of the generated sets. The evaluation value may be obtained by combining the degree of similarity of the first candidate and the degree of similarity of the second candidate, which are combined, and a degree of divergence between the period from the task start to the task end, that is, the task time, and the reference time (standard time span). The degree of deviation between the task time and the reference time may be obtained as a function of a deviation width. The function may simply obtain an absolute value, or may be a high-order function of a second or higher order such as obtaining the square of the deviation width. Even the skilled operator can have some variations in speed, but the operator who is accustomed to the task to a certain extent is unlikely to have a significant difference in the task time. Therefore, the function may be such that the degree of divergence does not change much when the deviation width is small, and the degree of divergence changes greatly and diverges when the deviation width increases to a certain extent or more.

The combination of the above-described three components in the calculation of the evaluation value may be, for example, a simple weighted average. Alternatively, the degree of similarity according to the first candidate and the degree of similarity according to the second candidate may be added by emphasizing the weight by a high-order function such as an exponential function, and may be further weighted and added by a function of the deviation width. Alternatively, conversely: the evaluation of the degree of similarity of each candidate may be considered relatively lightly compared to the function of the deviation width. The larger the evaluation value is, the higher the evaluation may be, or the smaller the evaluation value is, the higher the evaluation may be. Hereinafter, a description will be given on the assumption that the smaller the evaluation value is, the higher the evaluation is, and the larger the evaluation value is, the lower the evaluation is, that is, the degree of similarity is low or the deviation width is large.

Based on the evaluation value of the validity thus obtained, a set of the number of times of the task is selected so that the period is exclusive (P11). The steps of P10 and P11 correspond to the identifying step and the identifying means of the present embodiment. For example, the start and end of the task may be determined such that the maximum value of the evaluation values of the selected sets is minimized. More simply, a greedy method may be applied to the evaluation values to select a set of the number of times of task. That is, in a case in which the number of operations is known, the generated sets may be selected in ascending order of the evaluation value within a range in which the periods do not overlap each other until the number equal to the number of times of the task is selected.

Alternatively, the selection of the set may be performed by dynamic programming. In the dynamic programming, a path having the best evaluation value is searched for in a case in which the selection is performed in order from the second candidate included in the third candidate along the elapsed time so as to obtain a set of known numbers of times of the task. In this case, the evaluation value may be treated as the cost as it is. That is, the route having the smallest total evaluation value of the selected sets is the best route. The evaluation value (cost) of a combination with the h-th first candidate (h<i) that can be combined with the i-th second candidate at the elapsed time is denoted by c (h, i).

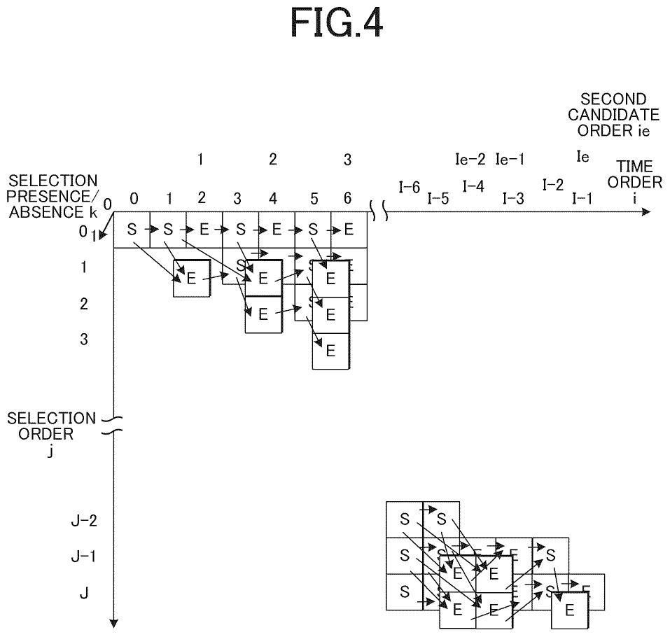

FIG. 4 is a diagram describing the dynamic programming. In the dynamic programming of the present embodiment, a three dimensional matrix represented by a time order i, a number of selections j, and the presence or absence of selection k is used for the first candidate S and the second candidate E included in the third candidate. (i, j) represents that a set of the second candidate E of the selection number j and the first candidate S corresponding thereto has been selected by the time order i, k=0 shows that the candidate of the time order i is not selected as the j-th ending timing, k=1 shows that the candidate of the time order i is selected as the j-th end timing. That is. (i, j, k) means that j (sets) are selected from among up to the i-th in the time order, and the candidate of the i-th in the time order is selected or not selected as the j-th set according to k. The time order i is 0≤i<I based on the total number i of the first candidate and the second candidate included in the generated third candidate.

In the dynamic programming method, while moving in a direction in which the time order i increases, the route branches into a route in which the selection number j does not change and a route in which the selection number j increases by one according to the selection presence or absence k. Among the paths from i=j=k=0) to the state represented by (i, j, k), the minimum value of the sum of the evaluation values c (h, i) of j selected sets is represented by the minimum cost p [i] [j] [k]. The path with the minimum cost to (i, j) passes through one of the paths with the minimum cost to (i−1, j) and (i−1, j−1) which can reach (i, j). If the number j of selections does not increase from the time order (i−1) to the time order i, p [i] is k=0 and the cost of the movement is zero. In time order (i−1), k can be either 0 or 1. On the route with the smallest cost to the time order i, the route to the time order (i−1) also needs to have the smallest cost. Therefore, p [i] [j] [0]=min (p [i−1] [j] [0], p [i−1] [j] [1]). If the i-th array element is included in the first candidate S. (i, j, k) is always k=0). There may be a case where the time order i is included in the second candidate E but is not selected.

In a case where the selection number j increases by one due to the selection during the movement in which the time order i increases by one, the cost c (h, i) according to the first candidate corresponding to the selected second candidate is generated. If the i-th is included in the second candidate E, it is selected and (i, j, k) may be k=1. In a case where k=1, p [i] [j] [1]=min (p [h] [j−1] [0]+c (h, i)) is satisfied. As described above, p [h] [j−1] [0] is the value of the minimum cost among the paths to the time order h by selecting (j−1) paths by the time order (h−1). Therefore, in a case where there are a plurality of time orders h of the first candidate S that can be selected correspondingly to the i-th second candidate E, the smallest value can be selected as the smallest cost p [i] [j] [1] from among the smallest costs p [h] and the sums of the costs c (h, i) combined with the smallest costs p [h].

The selected number j is max (0, ie −I−J+1)≤j≤min (ie, J) based on the number J of times of the task. The second candidate order ie represents the time order within the second candidate, max (0, ie −I−J+1) represents a larger value of 0 and “ie −I−J+1”, min (ie, J) represents the smaller value of ie and J. That is: (i, j) (0≤i<I, 0≤j≤J) may include elements that may not be included in the path. A large value such as infinity is set in advance for the minimum cost other than p [0] [0] [0]=0 that is the initial position, so that an impossible route is not selected. The time order i and the selection number j do not change in the decreasing direction.

Furthermore, since the (j−1)-th selection is limited to a case where the selection is performed before the h-th element in the time order, the overlap of the task periods is excluded. Therefore, the selectable path is limited to the path which can be finally selected by the predetermined number J of times of the task excluding the overlap. In other words, there is a path directly connected from the first candidate S having the time order of h to the second candidate E having the time order of i which is a target for determining the selection presence or absence k. For example, in FIG. 4, the second candidate E of i=2 can be connected from either of the first candidates S of i=0, 1. There may be no route for selecting the second candidate E a plurality of times in a row even within the range of the selected number j. For example, in FIG. 4, the second candidate E of i=1-4 and the second candidate E of i=1-3 cannot be selected simultaneously. By obtaining the value of the minimum cost in order from i=0), the path of the minimum cost to i=I−1 and j=J, that is. J sets to be selected are obtained.

The start timing and the end timing of each round of the task and the task period and the non-task period between the start timing and the end timing are specified by the second candidate of the number J of times of the task selected as described above from the extracted I pieces and the first candidate corresponding to the second candidate (P12).

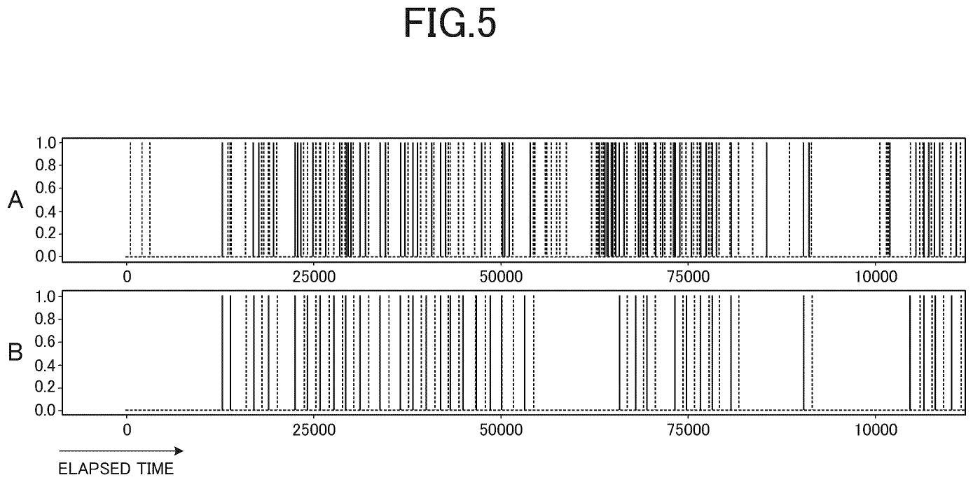

FIG. 5 is a diagram illustrating an example of an extracted candidate for the task start and the task end and an example of specified timings of the task start and the task end.

As shown in the upper stage (A), the task start and the task end may be continuously detected in the extraction stage, and the intervals of the extracted candidate are also non-uniform. The number of times of the task. i.e., the number of sets to be selected, is fixed, and the selection is made so as to make the task time uniform. As a result, as illustrated in the lower part (B), the start of the task indicated by the solid line and the end of the task indicated by the broken line appear alternately. Note that there is a portion where the end of the task and the start of the task are almost simultaneous and the two lines overlap each other.

Note that in a case where the number of times of the task is unknown, it is assumed that the number of times of the task is changed, and the same processing as described above is performed for each assumed number of times of the task. As a result, the combinations of start and end that is the same number as the provisional number of times of the task is temporarily specified. When the assumed number of times of the task is larger than the actual number of times, incorrect sets are always mixed. At this time, the evaluation value of the incorrect set tends to be significantly larger than the evaluation value of the correct set. Therefore, if the provisional number of times of the task and the maximum value among the evaluation values of the identified set of the provisional number of times of the task are associated with each other and their change trends are followed, the maximum value is also likely to be significantly large in a case in which the evaluation value in the incorrect set is mixed. That is, when the provisional number of times of the task exceeds the actual number of times of the task, it is expected that the maximum (worst) evaluation value significantly changes with respect to an increase in the provisional number of times of the task. The provisional number of times of the task at which such a worst change tendency of the evaluation value changes is identified as the actual number of times of the task.

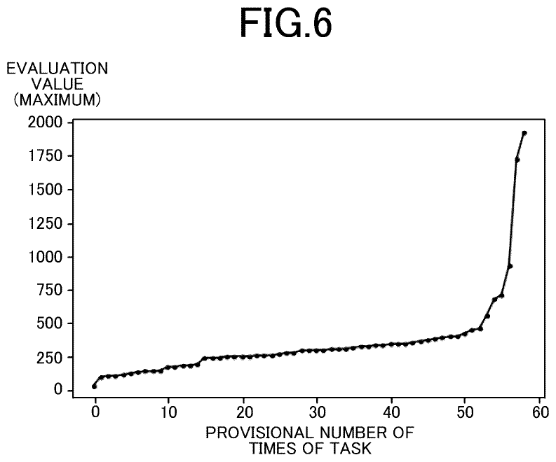

FIG. 6 is a graph illustrating a maximum value of an evaluation value with respect to the provisional number of times of the task.

As the provisional number of times of the task increases, the maximum value of the evaluation value gradually increases until 52 times. When the provisional number of times of the task exceeds 53 times, the maximum value of the evaluation value rapidly increases. Therefore, it is identified that the number of times of the task is 52 times. That is, a slope (difference) of the maximum value of the evaluation value with respect to the provisional number of times of the task may be calculated, and the provisional number of times of the task corresponding to a turning point at which the slope significantly changes may be specified as the number of times of the task. Alternatively, the difference of the difference (twice differential) between the maximum value of the evaluation values may be calculated, and the number of times of the task may be specified by the local maximum point.

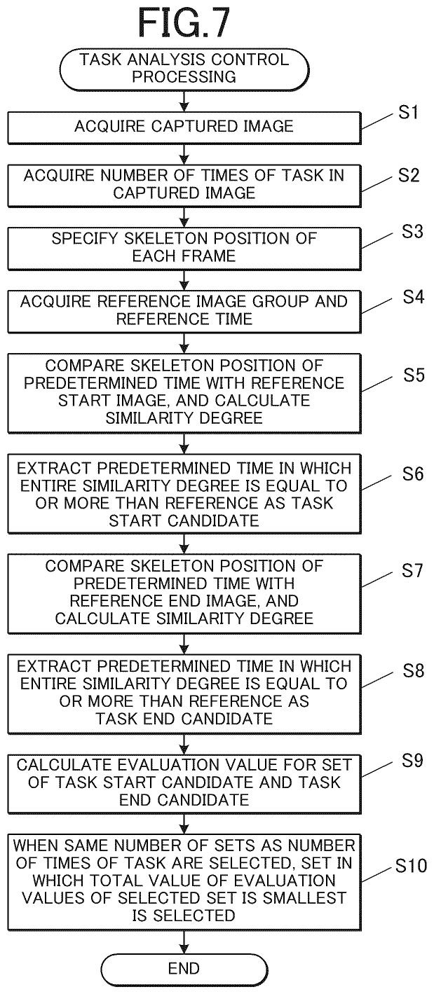

FIG. 7 is a flowchart illustrating a control procedure of task analysis control processing executed by the information processing apparatus 1 of the present embodiment. The task analysis control processing is processing in a case in which the number of times of the task is known. For example, the process may be started by a person in charge of using analysis data or providing the analysis data to the user performing a predetermined input operation on the operation reception section 15. In the input operation or the setting data, a captured image to be analyzed may be designated. Alternatively, the captured image placed in a specific folder may be automatically set as an analysis target.

The controller 11 acquires the captured image of the task (S1). The controller 11 may acquire the file at the specified position. The captured image may be acquired from a portable recording medium, an external device, or the like connected to the communication section 16.

The controller 11 acquires the number of times of the task in the captured image (S2). The number of times of the task may be acquired separately from the captured image based on, for example, the number of output products in the task process.

The controller 11 specifies the skeleton position of the person to be photographed in each frame data of the acquired captured image (S3). The skeleton position of the identification target may be only the upper body as described above.

The controller 11 acquires standard data indicating the skeleton position at a predetermined time at the start of the task and at the end of the task and the reference time per task (S4). The controller 11 calculates the similarity degree by comparing each frame of the standard data at the start of the task from the first frame of the imaging data in order (S5). The controller 11 extracts, as a task start candidate, a portion of the captured image in which the similarity degree over the entire predetermined time is equal to or greater than a standard (S6).

The controller 11 calculates the similarity degree by comparing each frame of the standard data at the end of the task from the first frame of the imaging data in order (S7). The controller 11 extracts, as a task end candidate, a portion of the captured image in which the similarity degree over the entire predetermined time is equal to or greater than the standard (S8).

The controller 11 sets the task start candidate and the task end candidate temporally subsequent to the task start candidate as a set and calculates an evaluation value of each set (S9). The controller 11 specifies a selection in which a value obtained by summing the evaluation values of the selected sets of the task is the smallest when the set of the task of which the periods do not overlap is selected for the number of times of the task (S10). Accordingly, the controller 11 specifies a set of the task start and the task end for the number of times of the task. In accordance with these, the controller 11 may specify the task time of each task and the interval between the tasks. Then, the controller 11 ends the task analysis control processing.

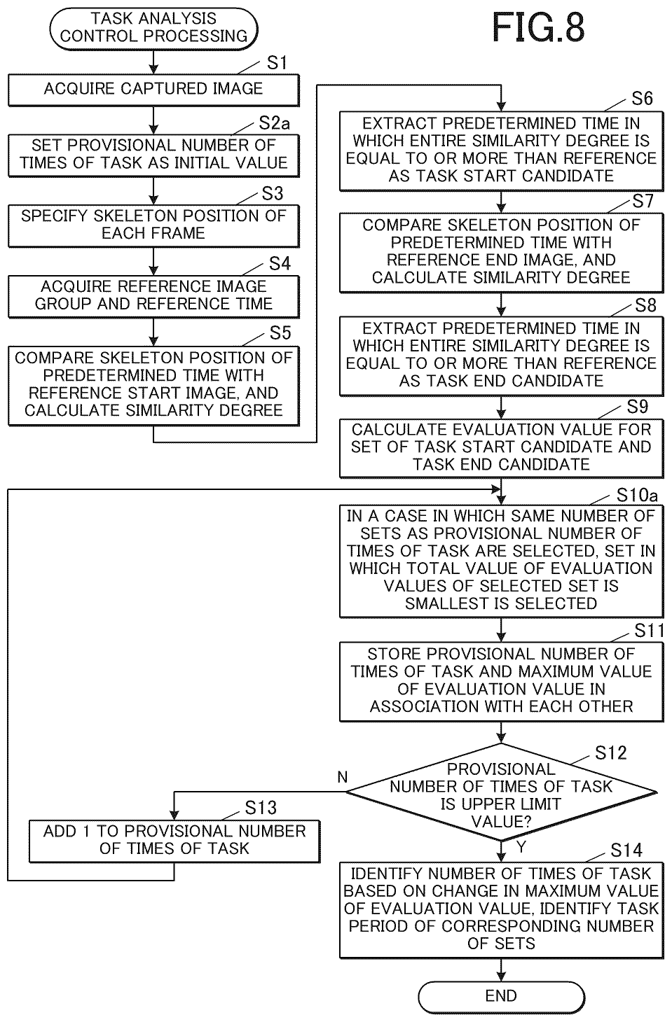

FIG. 8 is a flowchart illustrating another example of the task analysis control processing. The task analysis control processing is processing in a case in which the number of times of the task is unknown. In the task analysis control processing, the processing of the steps S2 and S10 in the task analysis control processing illustrated in FIG. 3 is replaced with processing of steps S2a and S10a, respectively, and steps S11 to S14 are added. The other processing is the same, the same processing content is denoted by the same reference sign, and detailed description is omitted.

In step S2a, the controller 11 sets an initial value of the provisional number of times of the task (S2a). As described above, since the number of times of the task is always 2 or more, the initial value is also an appropriate value of 2 or more. Thereafter, the processing of the controller 11 proceeds to step S3.

After the process of step S9, the controller 11 selects the same number of sets as the provisional number of times of the task (S10a). At this time, the controller 11 may select the set such that the value of the sum of the evaluation values of the selected sets of the task is minimized. The controller 11 stores the provisional number of times of the task and the maximum evaluation value in association with each other (S11).

The controller 11 determines whether or not the provisional number of times of the task is an upper limit value (S12). If it is determined that the provisional number of times of the task is not the upper limit value (S12:N), the controller 11 adds 1 to the provisional number of times of the task (S13). Thereafter, the processing of the controller 11 returns to step S10a.

If it is determined that the provisional number of times of the task is the upper limit value (S12:Y), the controller 11 specifies the number of times of the task on the basis of a change tendency of the maximum value of the evaluation value with respect to the provisional number of times of the task. As described above, the controller 11 specifies the provisional number of times of the task immediately before the maximum value of the evaluation value starts to rapidly increase on the basis of the difference value of the maximum value of the evaluation value, the difference value of the difference value, or the like, and specifies the provisional number of times of the task as the actual number of times of task. The controller 11 specifies the start timing and the end timing of each task according to the set selected corresponding to the specified number of times of the task (S14). Then, the controller 11 ends the task analysis control processing.

As described above, the task analysis method of the present embodiment includes the following steps. (1) A setting step of setting in advance the captured image of the operation of the operator at a start of a predetermined task as the reference start image, and setting in advance the captured image of the operation of the operator at an end of the task as the reference end image. (2) An acquisition step of acquiring the imaging data of the predetermined task repeated a plurality of times. (3) An extraction step of extracting, from the acquired imaging data, a first candidate for the operation at the start time based on a first similarity with the reference start image, and extracting a second candidate for the operation at the end time based on a second similarity with the reference end image. (4) A specifying step of specifying a task period by evaluating validity of a third candidate of the task period defined by a combination of the extracted first candidate and second candidate.

In this way, in identifying the task period, by identifying the starting movement and the ending movement thereof, the task period can be reliably identified. Furthermore, thus, the task period and the non-task period are clearly separated. On the other hand, even if the start operation and the end operation cannot be completely specified in accordance with the characteristics or the like, it is possible to exclude misrecognition by evaluating the combination. Therefore, according to the task analysis method, it is possible to more accurately specify the task time of the repetitive task.

In addition, in a case in which the number of times of the predetermined task repeated in the imaging data is known, the task period of the number of times of the task may be specified in the specifying step. If the number of times of the task is known in advance, it is sufficient to specify a task period that is equal in number to the number of times, thus reducing the possibility that a task period will be overlooked or a misidentified task period will remain.

In addition, the number of times of the predetermined task repeated in the imaging data may be unknown. In this case, in the identification step, while the number of times of the task is changed, the task period of each of the number of times of the task may be provisionally identified, and a value of the worst validity among the provisionally identified task periods may be associated with the number of times of task. The number of times of the task may be specified based on a change tendency of the validity value with respect to the number of times of the task with reference to the correspondence relationship obtained in this way. The task period provisionally identified with the identified number of times of the task is identified as a final task period. In this way, in the task analysis method of the present embodiment, even when the number of times of the task is unknown, the number of times of the task can be specified, and thus the task period can be specified with high accuracy.

Furthermore, the evaluation of the validity may be performed with the evaluation value based on the value indicating the first similarity, the value indicating the second similarity, and the value indicating the degree of divergence between the time width of the third candidate and the standard time span. By appropriately combining the similarity between the operation on the captured image and the operation in the reference image group with the validity of the time width of the task, it is possible to exclude an inappropriate combination of the first candidate and the second candidate and to more accurately determine the task period.

Furthermore, in the setting step, a predetermined skeleton position of the operator performing the predetermined task may be identified in each of the reference start image and the reference end image. In the extraction step, the predetermined skeleton position of the operator may be specified in the captured image at each timing in the imaging data. Each of the first similarity and the second similarity may be obtained using the predetermined skeleton position. It is possible to extract the first candidate and the second candidate more easily and accurately by performing the comparison focusing on the movement of the part that is characteristic in the operation of the operator rather than comparing the images themselves.

In addition, the first similarity and the second similarity may be obtained based on a characteristic vector that characterizes the operator at each timing in the reference start image and the reference end image and a characteristic vector that characterizes the operator in the captured image at each timing in the imaging data. That is, since the appropriateness of the first candidate and the second candidate can be objectively evaluated, it is possible to more accurately specify the task period.

Alternatively, the first similarity and the second similarity may be obtained by one of the sum of Euclidean distances of differences between characteristic vectors to be compared or the sum of cosine similarities, or the dynamic time warping method. In this way: in the task analysis method according to the present disclosure, since the similarity can be quantitatively evaluated by the easy vector operation, it is possible to reduce the possibility that the task period is erroneously recognized.

Further, the degree of divergence may be obtained by the absolute value of the difference between the time width of the third candidate and the standard time span, or the square of the difference. In most cases, the correct combination is included in many first candidates and second candidates. Therefore, even if the degree of divergence is represented by a simple function, an inappropriate combination of the first candidate and the second candidate can be easily excluded on the basis of the relative magnitude of the degree of divergence.

Furthermore, in the identifying step, the task period having the best validity may be identified using dynamic programming. With this task analysis method, the best task period is obtained with the optimum combination of the third candidate, and thus an optimum solution can be efficiently obtained.

The information processing apparatus 1, which is the information processing system of the present embodiment, includes a controller 11.

The controller 11 presets, as the reference start image, the captured image of the operation of the operator at the start of a predetermined task, and presets, as the reference end image, the captured image of the operation of the operator at the end of the task. The controller 11 acquires the imaging data on the predetermined task repeated a plurality of times. The controller 11 extracts, from the acquired imaging data, the first candidate of the operation at the start time based on the first similarity with the reference start image, and extracts the second candidate of the operation at the end time based on the second similarity with the reference end image. The controller 11 evaluates the validity of the third candidate of the task period defined by the combination of the extracted first candidate and second candidate, and specifics the task period. According to the information processing apparatus 1, it is possible to reliably specify the task period by specifying the start motion and the end motion of the task period. Furthermore, thus, the task period and the non-task period are clearly separated. On the other hand, even if the start operation and the end operation cannot be completely specified in accordance with the characteristics or the like, it is possible to exclude misrecognition by evaluating the combination. Therefore, according to the information processing apparatus 1, it is possible to more accurately specify the task time of the repetitive task.

Furthermore, by installing and executing the program 131 according to the task analysis method described above in a computer, it is possible to easily and with accuracy specify the task period of the repetitive task without the need for special hardware or the like.

Note that the present disclosure is not limited to the above embodiment, and various modifications are possible.

For example, although the first candidate and the second candidate are detected completely independently of each other in the above description, this is not limiting. For example, when the range of the first candidate and the range of the second candidate are detected in an overlapping manner, only one of the ranges having a higher degree of similarity may be selected.

In addition, in a case where the number of times of the task is unknown, the number of times of the task may be specified according to the number of times of switching between the presence and absence of an assembly target component appearing in the captured image.

In addition, in a case in which the worst evaluation value according to the provisional number of times of the task is used to specify the number of times of the task, the worst evaluation value and the task period may not be specified for all the provisional number of times of the task. For example, the worst evaluation value and the task period may be specified at appropriate intervals, and the worst evaluation value and the task period corresponding to all the provisional number of times of the task may be specified only in the vicinity of the provisional number of times of the task in which the change tendency of the worst evaluation value is estimated to change.

Furthermore, in the above description, the skeleton position is used to extract the operation feature of the operator to be imaged who is the operator, but it is not limited thereto. For example, the outline of the operator performing the specific task may be extracted, and the similarity or the like may be determined.

In the above description, the captured image itself of the operator who is the task analysis target is used as the reference image group, but the present disclosure is not limited thereto. For example, the reference image group may be used for task analysis of a plurality of operators in a case where it is difficult for an individual feature to appear in an operation at the time of task or a case where the feature not depending on an individual is conspicuous.

Furthermore, although the standard time span and the time width of the third candidate are simply compared with each other in the above description, it is not limited thereto. In particular, in a case such as DTW in which the calculation of the similarity degree includes a variation in the time axis direction, the degree of divergence may be adjusted according to the handling situation.

Furthermore, although the task analysis has been executed by a single information processing apparatus 1 in the description above, it is not limited thereto. The process may be performed in a distributed manner by a plurality of information processing apparatuses. The information processing apparatus 1 may be a part of a management system for the task.

Furthermore, in the above description, the storage section 13 including a nonvolatile memory such as an HDD or a flash memory has been described as an example of a computer-readable medium that stores the program 131 according to the task analysis control of the present disclosure, but the computer-readable medium is not limited thereto.

As other computer-readable media, other nonvolatile memory such as an MRAM and portable recording media such as a CD-ROM and a DVD disk can be applied. As a medium for providing data of the program according to the present disclosure via a communication line, a carrier wave is also applied to the present disclosure.

In addition, the specific configurations, the contents and sequence of the processing operations, and the like described in the above embodiment can be appropriately changed without departing from the scope of the present disclosure. It is intended that the scope of the present disclosure includes the scope of the invention described in the scope of the claims and the scope of equivalents thereof.

Although embodiments of the present disclosure have been described and shown in detail, the disclosed embodiments are made for purposes of illustration and example only and not limitation. The scope of the present disclosure should be interpreted by terms of the appended claims.

What is claimed is:

1. A task analysis method comprising:
presetting a captured image of an operation of an operator at a start of a predetermined task as a reference start image, and presetting the captured image of the operation of the operator at an end of the task as a reference end image;
acquiring imaging data of the predetermined task repeated a plurality of times;
extracting, from the acquired imaging data, a first candidate for the operation at the start based on a first similarity to the reference start image and a second candidate for the operation at the end based on a second similarity to the reference end image; and
specifying a task period by evaluating validity of a third candidate of the task period defined by a combination of the extracted first candidate and second candidate.

2. The task analysis method according to claim 1, wherein,
a number of times of the predetermined task repeated in the imaging data is known, and
in the specifying, the task period for the number of times of the task is specified.

3. The task analysis method according to claim 1, wherein,
the number of times of the predetermined task repeated in the imaging data is unknown, in the specifying,
the task period for each of the number of times of the task is provisionally specified while changing the number of times of the task, and the worst value of the validity among the provisionally specified task periods is associated with the number of times of the task,
the number of times of the task is specified based on a change tendency of the value of the validity with respect to the number of times of the task, and
specifies the provisionally specified task period with the specified number of times of the task.

4. The task analysis method according to claim 1, wherein the evaluation of the validity is performed with an evaluation value based on the value indicating the first similarity, the value indicating the second similarity, and the value indicating a degree of divergence between a time width of the third candidate and a standard time span.

5. The task analysis method according to claim 4, wherein,
in the setting, a predetermined skeleton position of the operator is specified in each of the reference start image and the reference end image,
in the extracting, the predetermined skeleton position of the operator is specified in the captured image at each timing in the imaging data, and
the first similarity and the second similarity are each obtained using the predetermined skeleton position.

6. The task analysis method according to claim 4, wherein the first similarity and the second similarity are obtained based on a characteristic vector characterizing the operator at each timing in the reference start image and the reference end image, and the characteristic vector characterizing the operator in the captured image at each timing in the imaging data.

7. The task analysis method according to claim 6, wherein the first similarity and the second similarity are obtained by one of a sum of Euclidean distances of differences between the characteristic vectors to be compared, a sum of cosine similarities, or a dynamic time warping method.

8. The task analysis method according to claim 4, wherein the degree of divergence is obtained by an absolute value of a difference between the time width of the third candidate and the standard time span or a square of the difference.

9. The task analysis method according to claim 1, wherein, in the specifying, the task period in which the validity is the best is specified using dynamic programming.

10. An information processing system comprising:
a hardware processor, wherein the hardware processor is configured to perform,
presetting a captured image of an operation of an operator at a start of a predetermined task as a reference start image, and presetting the captured image of the operation of the operator at an end of the task as a reference end image,
acquiring imaging data of the predetermined task repeated a plurality of times,
extracting, from the acquired imaging data, a first candidate for the operation at the start based on a first similarity to the reference start image and a second candidate for the operation at the end based on a second similarity to the reference end image, and
specifying a task period by evaluating validity of a third candidate of the task period defined by a combination of the extracted first candidate and second candidate.

11. A non-transitory computer-readable storage medium storing a program that causes a computer to perform,
presetting a captured image of an operation of an operator at a start of a predetermined task as a reference start image, and presetting the captured image of the operation of the operator at an end of the task as a reference end image,
acquiring imaging data of the predetermined task repeated a plurality of times,
extracting, from the acquired imaging data, a first candidate for the operation at the start based on a first similarity to the reference start image and a second candidate for the operation at the end based on a second similarity to the reference end image, and
specifying a task period by evaluating validity of a third candidate of the task period defined by a combination of the extracted first candidate and second candidate.
